(19) United States
(12) Patent Application Publication
(10) Pub. No.: US 2026/0037842 A1
(43) Pub. Date: Feb. 5, 2026

(54) Contrastive Explanations For Machine Learning Forecasting Models

(71) Applicant: Oracle International Corporation, Redwood Shores, CA (US)

(72) Inventors: Zahra Zohrevand, Vancouver (CA); Yasha Pushak, Vancouver (CA); Ritesh Ahuja, Los Angeles, CA (US); Hesam Fathi Moghadam, Sunnyvale, CA (US); Rhicheek Patra, Zurich (CH)

(21) Appl. No.: 19/047,337

(22) Filed: Feb. 6, 2025

Related U.S. Application Data
(60) Provisional application No. 63/679,036, filed on Aug. 2, 2024.

(51) Int. Cl. G06N 5/045; G06N 20/00

(52) U.S. Cl. CPC G06N 5/045; G06N 20/00

(57) ABSTRACT

A Contrastive Forecasting Explanation (CFE) tool and technique provides a model-agnostic approach to forecasting explanation. The CFE tool uses an ML-based surrogate forecaster as a surrogate model. The surrogate forecaster includes a time series preprocessor, a simple concept generator, and an ML forecaster. The subsequent interpretation of the predictions of the time series forecaster is based on the behavior of the surrogate forecaster. The CFE tool interprets time series forecasts by identifying the specific temporal concepts impacting predictions and thus generates clear and reliable explanations regardless of model type. The simple concepts and predictions generated by the surrogate model are input into a perturbation-based explainer to produce feature attributions from the surrogate model. An attribution postprocessor aggregates the attributions into more coherent concepts to present a coherent, concise, and interpretable explanation.

### BENEFIT CLAIM

This application claims the benefit of Provisional Application 63/679,036, filed Aug. 2, 2024, the entire contents of which are hereby incorporated by reference as if fully set forth herein, under 35 U.S.C. § 119 (e).

### FIELD OF THE INVENTION

The present invention relates to machine learning explainability tools and, more specifically, to contrastive explanations for machine learning forecasting models.

### BACKGROUND

The complexity and opacity of advanced high-performing models highlight the imperative need for the development of explainable algorithms which aim to provide insights into decision-making processes used by models, especially in mission-critical applications. In recent years, there has been a growing emphasis on enhancing the interpretability of machine learning models. Explainable artificial intelligence (XAI) is a set of processes and methods that allow human users to comprehend and trust the results and output created by machine learning models. XAI techniques seek to render machine learning models transparent and interpretable for human understanding. This transparency helps users comprehend the behavior, decisions, and predictions of the model.

Explainable AI is used to describe an AI model, its expected impact and potential biases. XAI helps characterize model accuracy, fairness, transparency and outcomes in AI-powered decision making. Explainable AI is crucial for an organization in building trust and confidence when putting AI models into production. AI explainability also helps an organization adopt a responsible approach to AI development.

As AI becomes more advanced, humans are challenged to comprehend and retrace how a particular machine learning (ML) model came to a result. The whole machine learning process becomes what is commonly referred to as a “black box” that is impossible to interpret. These black box models are created directly from data. Even engineers or data scientists who create ML models cannot necessarily understand or explain what happens inside an ML model or how the model arrived at a specific result.

There are many advantages to understanding how an ML model has arrived at a specific output. Explainability tools can help developers ensure that the system is working as expected, explainability might be necessary to meet regulatory standards, or it might be important in allowing those affected by a decision to challenge or change a predicted outcome.

XAI techniques can employ three main methods. Prediction accuracy and traceability address technology requirements while decision understanding addresses human needs. Furthermore, multiple types of XAI techniques exist, including local, cohort, and global explainability. Local explainability emphasizes a specific decision made by the model and input features impacting that decision. Local explainability answers questions for a specific output of the model. Cohort explainability is applicable to a certain cohort or subset of data. Cohort explainability helps in understanding the model and its features' role in prediction output for a certain set of data, thus providing insights regarding bias and performance. Global explainability takes a holistic view of model explanation, assisting the user in understanding the role and impact of input features on the output, considering the whole population. It helps to understand the overall performance of the model.

A time series is a series of data points indexed in time order. Most commonly, a time series is a sequence taken at successive, equally spaced points in time. Time series forecasting is the use of a model to predict future values based on previously observed values. While the XAI community has introduced various explanation techniques for classification, regression, and anomaly detection tasks, efforts in explaining forecasting are infrequent and predominantly concentrated on machine learning forecasting methods.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating a computer tool for providing a Contrastive Forecasting Explanation (CFE) for a time series forecasting machine learning model in accordance with an embodiment.

FIG. 2 depicts pseudocode for concept generation in accordance with an embodiment.

FIG. 3 illustrates an example of an original series along with the forecasting horizon in accordance with an embodiment.

FIG. 4 depicts an example output of a contrastive forecasting explainer tool in accordance with an embodiment.

FIG. 5 is a flowchart illustrating operation of a contrastive forecasting explanation tool for providing a concept-based contrastive explanation for a forecasting model in accordance with an embodiment.

FIG. 6 is a block diagram that illustrates a computer system upon which aspects of the illustrative embodiments may be implemented.

FIG. 7 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Complex models require transparent and explainable algorithms. While current industry and state-of-the-art methods explain classification, regression, and anomaly detection, they lack adequate techniques for time series forecasting. Time series forecasting explanation involves interpreting and understanding the predictions generated by a time series forecasting model. To explain the behavior of a time series model, the time series can be decomposed into temporal concepts that are humanly understandable (e.g., trend, seasonality, lag, and cyclic patterns) following a tedious procedure that is custom-built for each model. In time series data, seasonality refers to the trends that occur at specific regular intervals, such as weekly, monthly, or quarterly. Seasonality may be caused by various factors, such as weather, and consists of periodic, repetitive, and generally regular and predictable patterns in the levels of a time series. In time series analysis, lag refers to a delay between an observed data point and its preceding values. Specifically, lag is the time difference between two observations in a sequence, or the number of steps back in time a past observation is from the current time.

The illustrative embodiments provide a Contrastive Forecasting Explanation (CFE) tool and technique, which is a model-agnostic approach. The CFE technique takes advantage of the application-domain embedded context, which users of the approach implicitly have, of the business workflows or events that led to values of the time series at certain historical timepoints. By allowing users to specify such a datapoint as a “reference point,” the CFE technique explains forecasts by comparing forecasted samples to reference observations. The CFE technique interprets time series forecasts by identifying the specific temporal concepts impacting predictions and thus generates clear and reliable explanations regardless of model type.

The CFE technique provides a valuable tool for the Explainable AI (XAI) and forecasting communities, enabling better understanding of, and trust in, time series forecasting models. Many people have a distrust in AI, yet to work with it efficiently, users must learn to trust results of ML models. Thus, by providing improved explainability tools, the illustrative embodiments provide an improvement to the field artificial intelligence and machine learning. The CFE tool of the illustrative embodiments achieves improved accuracy by introducing a surrogate-based process to provide consistent explanation across different models including statistical forecasters.

Furthermore, the CFE tool of the illustrative embodiments achieves improved trust and adoption of ML technology by explaining a forecasted value relative to a reference point. The CFE tool denotes a specific data point in the time series as a reference point, and then to explain a forecasted value, the tool highlights the importance of key driving factors by comparing their values at the forecasted timepoint against their values at the given reference timepoint (“then” vs “now”). The resulting explanations are framed in terms of human-understandable temporal concepts (e.g., periodicity and trend).

Existing explanation methods for time series forecasting outcomes primarily target machine learning and deep models, rendering them less applicable to statistical forecasters. In contrast, the contrastive forecasting explainer of the illustrative embodiments introduces features that improve accuracy and performance. The contrastive forecasting explainer of the illustrative embodiments offers a unified approach based on surrogating the original forecasting model to cater to various models, including statistical forecasters, tabular machine learning forecasters, deep recurrent forecasters, and even LLM meta-learners. This inclusive approach ensures that our explanation methods can seamlessly adapt to various forecasting models, irrespective of their modeling or implementation complexity or limitations. The CFE tool is specifically designed to explain all forecasting methods in a model-agnostic manner. By centering the design around an internal surrogate model, the CFE tool provides unified explanations across various forecasting techniques. Whether a model employs statistical methods or machine learning strategies, the CFE tool adapts seamlessly, ensuring consistent and coherent interpretation.

Furthermore, the illustrative embodiments provide the surrogate model concept-based approach in the context of forecasting. CFE takes advantage of the application-domain embedded context of the business workflows or events, which users of the approach implicitly have, that led to the value of the time series at certain historical timepoints. Thus, the CFE tool enhances user understanding by employing a specific data point as a reference and highlighting the impact of key driving factors by comparing their values at the target of explanation against those at the given reference point. The CFE tool simplifies complex concepts into easy-to-understand explanations by framing them in terms of temporal concepts like periodicity and trend, enhancing user comprehension. By comparing the driving factors at the prediction point to those at a reference point which the user is typically familiar with, users can more easily grasp how these factors influence the outcome, making the explanations clearer and more intuitive.

The CFE approach enhances the interpretability of statistical forecasting, a domain often overlooked by conventional explanation methods designed for machine learning and deep neural-network models. Although statistical models are inherently white-box, interpreting their results based on complex parametric equations can be challenging for end-users, and no dedicated method exists to break them down into easy-to-understand concepts. Existing multi-purpose model-agnostic explainers, such as permutation-based techniques, are not suitable for these models because statistical models are not designed to have their forecast values perturbed by altering historical endogenous variables.

The CFE approach can be extended to support large language models (LLMs) as meta-learned forecasting models. This can be fully model agnostic, generating a complete feature engineering loop and explaining the LLM meta-learner. Additionally, it can also leverage LLM insights to iteratively update engineered features, enhancing the accuracy and interpretability of our forecasting models.

Moreover, the CFE tool of the illustrative embodiments is relatively fast as it reduces the problem of explaining the prediction of time series forecasting to a point-to-point comparison. This is quicker compared to other feature-importance based explainability methods, which typically analyze the full history of training data to explain a specific prediction.

### Explainability of Forecasting Models

Forecasting holds substantial significance across industries, from finance to supply chain management, leading to an increasing demand for transparent explanations of its results. Forecasting, as a technique, involves predicting future values based on historical data and distinctive trends. For instance, forecasting the average annual company turnover using data from the past 10+ years differs from conventional predictive ML tasks (classification, regression, etc.) in several ways:
Data Type: Time series input assumes the presence of periodicity in regularly spaced timestamped events, distinguishing it from tabular predictive models that often overlook the sequential or temporal aspect of data.
Prediction Task: Forecasting models leverage both the temporal (sequential) aspects of endogenous and exogenous features (commonly in ML forecasters) to make predictions. In contrast, other predictive models, such as classification and regression models, treat input samples as separate entities and may not consider their potential relationships.

Time series forecasting explanation entails interpreting and comprehending the predictions generated by a time series forecasting model. Here are key aspects of this process:
Model Explanation: Explaining the forecasting model helps in understanding how individual time series concepts contribute to the overall improvement in model performance.
Prediction (Forecasting) Explanation: The explanation of a forecasted value involves examining the specific concepts that impact the value of a particular forecasted sample. Concepts are underlying factors or patterns that contribute to the observed data. In the realm of time series, these concepts often encompass characteristics such as trend, seasonality, and cyclic patterns.

Explaining temporal forecasting techniques presents distinct challenges due to the following reasons:
Complex Temporal Sequences: These techniques rely on extracting patterns from highly autocorrelated and stochastic temporal sequences, adding complexity to the problem. The accuracy of an explanation is crucial as it should faithfully represent the actual situation; otherwise, it might mislead rather than enlighten.
Statistical Forecasting Tools: Many industrial forecasting tools, including the CFE techniques of the illustrative embodiments, are based on or incorporate statistical forecasting techniques. It is important to recognize that interpreting the results of statistical models differs significantly from interpreting data-driven ML models. Statistical forecasting models are parametric in nature, if the data follows a specific distribution and can be described by a fixed number of model parameters. These constraints are incompatible with typical model-agnostic explainers, such as perturbation-based techniques, because “perturbations” of the data features alter the model parameters (i.e., the predetermined functional form fitted to the data), rather than only modifying the predictions. While statistical models are inherently white-box and explainable, interpreting their results based on complex parametric equations can be challenging for end users who are not statisticians.

Most existing explainability techniques provide explanation support primarily for ML time series models, focusing predominantly on time series classification and regression tasks rather than forecasting.

There is an oversight in using Kernel SHAP or other attributive explainers for time series-related tasks, where the sequential (temporal) aspect of data is often neglected in Tabular SHAP explanations. Existing techniques like Kernel SHAP are designed primarily for tabular data and treat only collective feature correlations. However, time series data have inherent temporal dependencies where each time point is not independent but is influenced by preceding and succeeding time points. Passing raw time series data to such explainers without accounting for these correlations can result in misleading interpretations due to collinearity. Therefore, it is desirable to develop or adapt explainability methods that explicitly consider these temporal relationships to accurately explain the impact of each time point on the final prediction, ensuring a more faithful and insightful understanding of model behavior for time series data.

A limited number of existing techniques, including H2O-AI, and OmniXAI, utilize generic regression explainers that often produce explanations for forecasts through complex and non-intuitive correlations. These explainers are not specifically designed for forecasting tasks and encounter several challenges, such as high-dimensionality issues during the perturbation process. Furthermore, their explanations are based on historical observations at specific time points, which can be difficult to interpret and not particularly useful for users. Additionally, these methods do not extend to statistical techniques.

To support forecasting explanation, overcome the potential challenges, and provide a useful and helpful explainer, we propose to integrate a contrastive explanation approach defined based on human-understandable temporal concepts. This approach offers a model-agnostic explainer that considers the unique requirements of forecasting tasks. The detailed algorithm for the technique is elaborated in the following section.

### Contrastive Forecasting Explanation

The illustrative embodiments provide a surrogate-based process that allows for consistent explanations across different models, including statistical forecasters. The surrogate-based process generates a “contrastive forecasting explanation,” which denotes a specific data point in the time series as a reference point, and then to explain the forecasted value, highlights the importance of key driving factors by comparing their values at the forecasted time point against their values at the given reference timepoint (“then” vs “now”). The resulting explanations are framed in terms of human-understandable temporal concepts, like periodicity and trend.

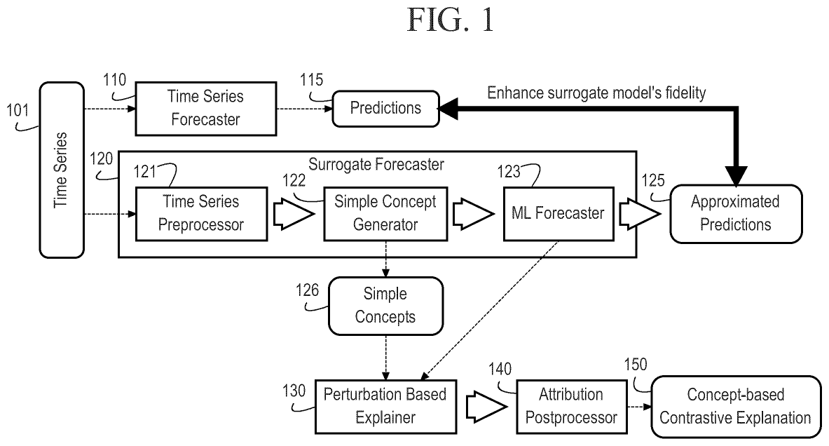

FIG. 1 is a block diagram illustrating a computer tool for providing a Contrastive Forecasting Explanation (CFE) for a time series forecasting machine learning model in accordance with an embodiment. The computer tool provides a concept-based explanation for time series forecaster 110 based on time series 101. Time series forecaster 110 generates predictions 115 based on time series 101.

To approximate the behavior and predictions of an input forecasting model, such as time series forecaster 110, the computer tool in FIG. 1 uses an ML-based surrogate forecaster 120 as a surrogate model. Surrogate forecaster 120 includes time series preprocessor 121, simple concept generator 122, and ML forecaster 123. The subsequent interpretation of the predictions 115 of the time series forecaster 110 is based on the behavior of this surrogate forecaster 120.

Initially, the predictions 115 of the original model for the training stage are preprocessed by the time series preprocessor 121 through scaling and de-trending to facilitate the training of an ML regressor. If the original model does not support in-sample prediction, its existing predictions are used instead. Then, if a statistical forecasting model is to be explained, its formula is examined to identify the statistical concepts it employs (e.g., trend, seasonality, period). Thus, the CFE tool provides a systematic approach to train a surrogate model that is highly faithful to the original forecasting model. In situations where the surrogate model predictions diverge from the original model, a re-scaling mechanism is employed to align them and minimize discrepancies.

Subsequently, the simple concept generator 122 creates a set of features, simple concepts 126, related to key concepts like seasonality and trend, which were utilized by the original forecasting model 110. If information about the original model 110 is not available, a default set of similar ML-based features is generated, as described in further detail below. The CFE tool employs a minimal set of interpretable concepts to encompass the various technical measures considered in forecasting methods, particularly statistical forecasting methods.

In a training phase, surrogate ML forecaster 123 is trained using simple concepts 126 generated by simple concept generator 122, with the original forecast model predictions 115 as the target of the training. In other words, time series preprocessor 121 performs preprocessing on time series 101, and simple concept generator 122 generates simple concepts that are used as inputs to ML forecaster 123. The ML forecaster 123 is trained to generate approximated predictions 125 using predictions 115 as the target of the training.

In an inference phase, the simple concepts 126 and approximated predictions 125 generated by the surrogate model 120 are input into a perturbation-based explainer 130 to produce feature attributions from the surrogate model 120. The obtained attributions are scaled by attribution postprocessor 140 to explain the differences between the approximated predictions 125 and reference values from the original model 110. This is achieved through a systematic technique involving mathematical conversion that addresses discrepancies between the original and surrogate model predictions.

Finally, attribution postprocessor 140 aggregates the attributions into more coherent concepts to present a coherent, concise, and interpretable explanation 150.

### Time Series Preprocessor

In some embodiments, time series preprocessor 121 is designed to prepare data for surrogation using a tabular ML forecaster. This involves several preprocessing steps, such as de-trending, power transformation, and data scaling. While various techniques can be applied for de-trending, the common methods include differencing and moving averages.

Differencing is a de-trending technique that involves subtracting the previous observation from the current observation to remove trends in time series data. In one embodiment, the following equation can be used for differencing:

$${y}_{t}^{′} = {y}_{t} - {y}_{( t - 1 )}$$

De-trending using a moving average involves calculating the average value over a specified window of time and subtracting this moving average from the original time series data to remove the trend component. In one embodiment, the following equation can be used for de-trending using a moving average:

$${MA}_{t} = \frac{1}{n} {\sum }_{i = 0}^{n - 1} {y}_{( t - 1 )} ⇒ {y}_{t}^{′} = {y}_{t} - {MA}_{t}$$

Experiments show that using moving average de-trending is more robust, facilitates easier and more reliable post-processing, and helps in accurately evaluating trend impact within the framework of the CFE tool.

### Simple Concept Generator

Simple concept generator 122 is designed to generate a set of straightforward and easily comprehensible statistical concepts for training the surrogate model. The final explanation is derived by aggregating the importance of each group of these concepts, ensuring it is completely understandable to users.

Before generating these concepts, the input time series 101 undergoes windowing, with the window size determined by the largest value of the detected seasonality period. Initially, the lags and seasonality levels are extracted in the preprocessing stage 121. However, if the concept generator 122 has access to the concepts used within the original model 110, it filters the set of lags and seasonality levels accordingly. For example, if the preprocessor 121 detects seasonality levels of 7 and 28, but the original model, such as SARIMAX, only uses a seasonality level of 7, then only the seasonality level of 7 is retained for the feature engineering process. This is to ensure greater alignment with the forecasting model 110 that is to be explained.

Subsequently, a set of lagging features are generated, which are aligned with specific historical time offsets to capture seasonality periods and seasonal autoregressive trends. Additionally, based on the existing seasonality levels, the following default set of windowing features are generated:
Mean and Median: Calculated to mimic moving averages.
Min and Max: Evaluated to estimate capacity thresholds.
Kurtosis and Skew: Used to simulate residuals. Kurtosis is a measure of how differently shaped the tails of a distribution are compared to the tails of the normal distribution. While skewness focuses on the overall shape, Kurtosis focuses on the tail shape.
Variance: Measured to estimate heteroskedasticity, especially at medium window sizes.

However, if simple concept generator 122 is aware of the model and the types of concepts employed within it, the above set of features is not generated, and only those used by the model are created. For instance, if the model 110 is a Naïve Forecaster designed to use only the mean value within the given seasonality, the generation of additional features is skipped. If such information is not provided, the full set of features is generated.

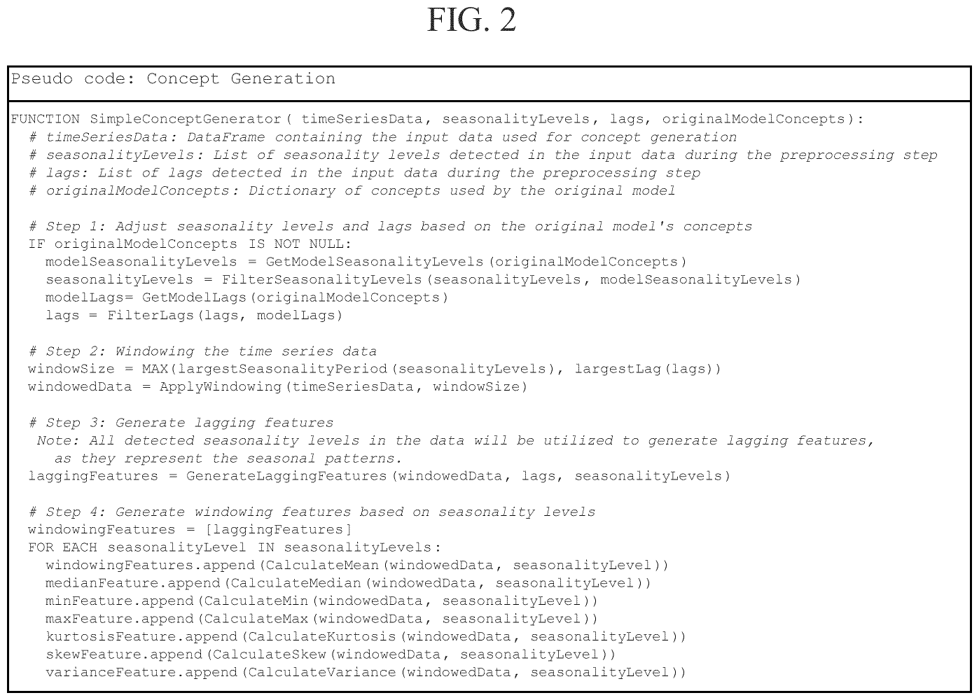

FIG. 2 depicts pseudocode for concept generation in accordance with an embodiment. As shown in FIG. 2, the simple concept generator function accepts as inputs time series data, seasonality levels, lags, and original model concepts. In one embodiment, the time series data is a data frame containing the input data used for concept generation. The seasonality levels are a list of seasonality levels detected in the input data during the preprocessing step. The lags are a list of lags detected in the input data during the preprocessing step. The original model concepts are a dictionary of concepts used by the original model.

In a first step, the simple concept generator function adjusts seasonality levels and lags based on the original model's concepts. In some embodiments, the simple concept generator function filters seasonality levels and lags identified during preprocessing based on the seasonality levels and lags of the original model. In a second step, the simple concept generator function applies windowing to the time series data. In some embodiments, the window size is set to the maximum of the largest seasonality period and the largest lag. In a third step, the simple concept generator function generates lagging features. All detected seasonality levels in the data are utilized to generate lagging features, as they represent the seasonal patterns. In a fourth step, the simple concept generator function generates windowing features based on the seasonality levels. In some embodiments, these windowing features include mean, median, minimum, maximum, kurtosis, skew, and variance.

### Surrogate ML Forecaster

In one embodiment, a tabular ML-based forecasting model 123 is used to approximate the behavior of the original forecaster 110. To achieve better approximation, the surrogate model is trained using the original model's predictions 115 in-sample (i.e., for the entire training set) and out-of-sample (i.e., over the forecasted horizon). If the model's concepts are exposed to the simple concept generator module 122, the surrogate model is trained based on a minimal set of features provided by the model. If surrogation fidelity is not acceptable, simple concept generator 122 can produce all features, increasing the chance of achieving fidelity to the original model.

However, there is significant room for improvement to ensure the surrogate model accurately captures the complexities of the original model. For instance, implementing an iterative surrogation process can enhance fidelity. Additionally, enriching the simple concept generator component 122 can contribute to improvements in the surrogate model 123.

While training the surrogate model may be skipped for ML models, there are two main reasons for training the surrogate model: (1) it ensures a unified explanation across all types of forecasting models; and (2) it generates more interpretable explanations based on easy-to-understand concepts rather than raw time points.

### Perturbation-Based Explainer

At this stage, any perturbation-based feature importance technique that handles perturbations based on a reference point can be utilized to generate feature importance from the surrogate model's predictions. Among these techniques, Kernel SHAP has good performance and the ability to consider the sequential relationships within the data during coalition generation. This capability ensures that the temporal dependencies and patterns inherent in time series data are appropriately captured, leading to more accurate and meaningful feature importance scores.

### Attribution Postprocessor

The attribution post-processor is responsible for the following tasks:
1. Inverse-transforming the scales of target and reference predictions: This process involves reversing the initial transformations applied to the data to retrieve the values of the reference and target points in the original data scale. Consequently, the final attributions will also be adjusted according to the new scale of the values.
   Inverse Scaling Transformation: Assume the original data yₜ undergoes a scaling transformation to produce yₜ′. To retrieve the original values from the scaled data, attribution postprocessor 140 applies the inverse transformation.
   Re-trending: As mentioned above, attribution postprocessor 140 also de-trends the data from the preprocessing step, which involves decomposing the time series such that the impact of the trend component is isolated into a separate time series. As a result, “re-trending” is as easy as adding the trend component back to the remaining data. Meanwhile, the re-trending impact (estimated moving average in one embodiment) is added to the set of attributions. To simulate the moving average in the forecasting horizon, attribution postprocessor 140 uses a simple linear regressor to predict the moving average values after the last observed data point.
      Linear Regression for Trend Prediction: Assume [symbol] =∝+βt is the prediction at time t, where ∝ and β are coefficients estimated from the historical data.
      Applying Moving Average: We use moving average for re-trending as below:

$${\hat{y}}_{t} = + {y}_{t}^{′}$$

where MAₜ is the moving average at time t, and ∈ is the residual error term.
2. Ensuring sum of attributions matches differences in target and reference values: The positive and negative attributions should sum to the difference between the target value and reference value in the original model. However, due to slight discrepancies between the surrogate model's predictions and the original model's predictions, they sometimes do not. To address this, attribution postprocessor 140 minimally scales the attributions to ensure the numbers add up correctly. Therefore, attribution postprocessor 140 starts with the constraint:

$$possitiveAttributions \cdot x + \frac{negativeAttributions}{x} = {Diff}_{o} ,$$

where Diffₒ is the difference between the original model's prediction and the reference value and possitiveAttributions and negativeAttributions represent the sum of all of the positive and negative attributions, respectively, such that:

$$possitiveAttributions + negativeAttributions = {Diff}_{s} ,$$

where Diffₛ is the difference between the surrogate model's target and reference predictions. Attribution postprocessor 140 then solves for x. Since this is a quadratic equation, it has two roots; however, one of them always changes the sign of the positive and negative attributions to make them negative and positive, respectively, so attribution postprocessor uses only the root that preserves the sign of the attributions. That is:

$$x = \frac{{Diff}_{s} + \sqrt{{Difff}_{s}^{2} - 4 \cdot positiveAttributions \cdot negativeAttributions}}{2 \cdot positiveAttributions}$$

In some rare cases, this strategy can fail; for example, if there are no positive or negative attributions and the original difference is negative or positive, respectively, then this solution produces a division by 0 error. In such cases, attribution postprocessor 140 instead multiplies the non-zero attributions by whatever constant value is necessary to obtain the desired difference.
3. Aggregating Attributions into Understandable Concepts: The final step involves consolidating the detailed feature attributions into comprehensible and orthogonal concepts, as explained above with respect to the concept generator component. These concepts include trend, seasonality levels, capacity thresholds, and changing variance. For instance, instead of listing individual attributions like Min and Max, it might be more interpretable to aggregate them and describe their combined impact as “Capacity Threshold,” a non-technical term that refers to the upper/lower limits on the data of a time series that are inherent to the application domain (e.g., consumption of a resource may never exceed 100%, or the value of a stock may never be lower than 0$).

### Concept-Based Contrastive Explanation

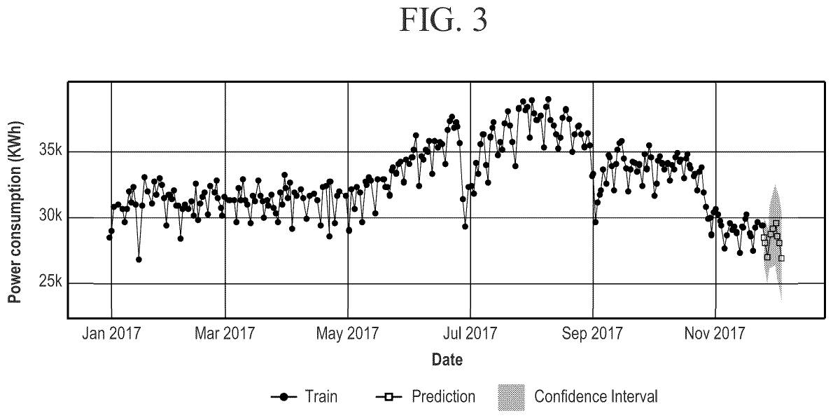

Consider a user who possesses a forecasting model trained on a dataset enriched with exogenous variables, such as temperature, humidity, wind speed, general diffuse flows, and diffuse flows, to predict power consumption of a zone. FIG. 3 illustrates an example of an original series along with the forecasting horizon in accordance with an embodiment. The user is interested in exploring the predictions of a model and seeks to understand the influence of various temporal concepts and external features on the outcomes. Thus, the user invokes the forecasting explainer for the estimator and unveils the internal mechanisms of the model for future forecasts.

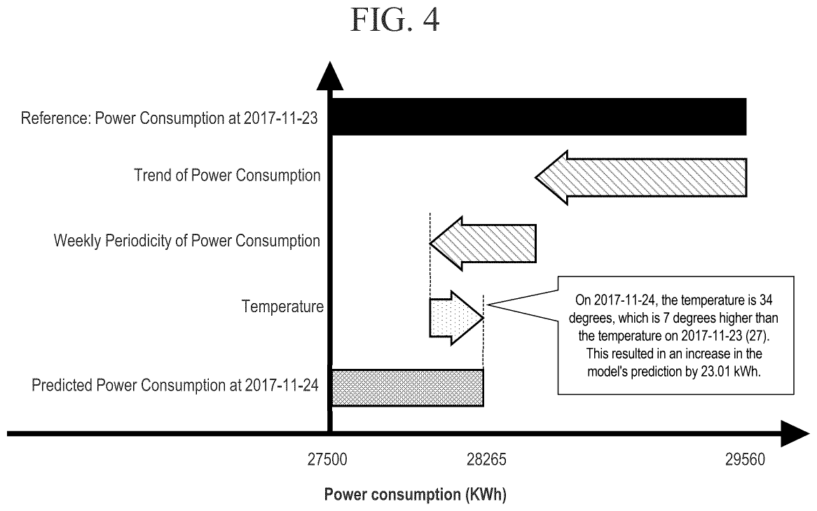

FIG. 4 depicts an example output of a contrastive forecasting explainer tool in accordance with an embodiment. In the example shown in FIG. 4, the output of the CFE tool is presented in the format of a waterfall plot, which shows how the value at the explained prediction (e.g., predicted power consumption at 2017 Nov. 24) compares to that at the reference point (e.g., power consumption at 2017 Nov. 23). The plot highlights the impact of each feature (e.g., trend, periodicity) in changing the value of the forecast at reference point to the target prediction from the model. Each feature contribution, categorized as positive or negative, can be tracked by following the right and left arrows, respectively. A higher importance score means a stronger link between a feature and the difference in forecasts. Also, hovering over the bars exposes more details on how each predictor affects the forecasting results.

For example, the analysis from the explainer in the plot shown in FIG. 4 indicates that the primary factor influencing the trained model is historical data, with a particular emphasis on data trends. Specifically, there is a decreasing trend in power consumption on the prediction day in comparison to the level observed on the reference day. This reduction has resulted in the model predicting a lower power consumption reduced by approximately 1,200 KWh. Additionally, the weekly periodicity pattern has similarly contributed to a decrease in the forecast. In contrast, variations in the exogenous feature “temperature” have increased the forecast. Consequently, the final prediction stands at 28,265, lower than the reference value of 29,560.

### Procedural Overview

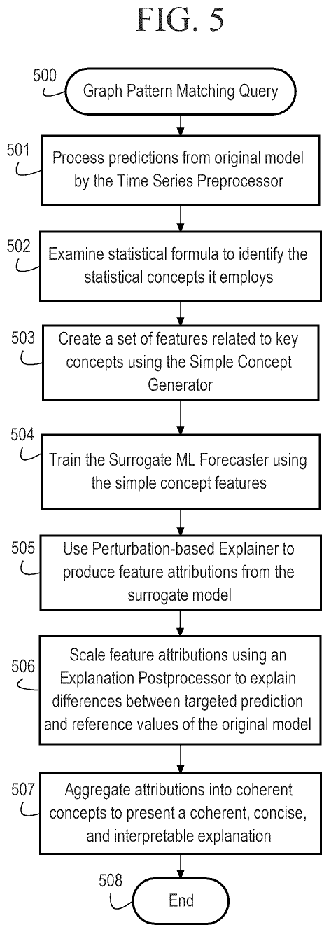

FIG. 5 is a flowchart illustrating operation of a contrastive forecasting explanation tool for providing a concept-based contrastive explanation for a forecasting model in accordance with an embodiment. Operation begins with a prediction generated by a time series forecaster (block 500). The CFE tool processes predictions from the original model using a time series preprocessor (block 501). In some embodiments, this involves several preprocessing steps, such as de-trending, power transformation, and data scaling. In one embodiment, the CFE tool then examines a statistical formula of the original model to identify the statistical concepts it employs (block 502).

The CFE tool then creates a set of features related to key concepts using a simple concept generator (block 503). The simple concept generator generates a set of straightforward and easily comprehensible statistical concepts for training the surrogate model. The final explanation is derived by aggregating the importance of each group of these concepts, ensuring it is completely understandable to users.

The CFE tool trains a surrogate ML forecaster using the simple concept features (block 504). In one embodiment, a tabular ML-based forecasting model is used to approximate the behavior of the original forecaster. To achieve better approximation, the surrogate model is trained using the original model's predictions. Training the surrogate ML forecaster ensures a unified explanation across all types of forecasting models and generates more interpretable explanations based on easy-to-understand concepts rather than raw time points.

The CFE tool uses a perturbation-based explainer to produce feature attributions from the surrogate model (block 505). The CFE tool then scaled feature attributions using an explanation postprocessor to explain differences between the targeted prediction and the reference values of the original model (block 506). The CFE tool aggregates the attributes into coherent concepts to present a coherent, concise, and interpretable explanation (block 507). In the illustrative embodiments, the contrastive forecasting explanation generated by the CFE tool provides a contrastive explanation that compares predicted samples to reference observations. Thereafter, operation ends (block 508).

### Quality Assessment of Surrogation Process

To evaluate the quality of the surrogation process, an assessment was performed of the fidelity-defined as the surrogate model's capability to approximate the behavior of the original model. This evaluation was conducted using a subsample of 80 univariate time series from the M4 benchmark at various levels of granularity, alongside a collection of 58 synthetic datasets; these synthetic datasets were generated based on a variety of frequencies, types, and combinations of seasonalities and trends.

The quality of the models is evaluated based on three common metrics:
R2 (Coefficient of Determination): Measures how well the model's predictions match the actual data, with 1 being perfect and 0 indicating no explanatory power.
RMSE (Root Mean Squared Error): Indicates the average magnitude of prediction errors. Lower values mean better fit.
SMAPE (Symmetric Mean Absolute Percentage Error): Measures prediction accuracy as a percentage, with lower values indicating higher accuracy.

The experiment is designed to evaluate the quality of surrogate models and the original model in the following settings:
Quality of the Original Model: Evaluated based on its predictions compared to real-world observations.
Quality of the Surrogate Model: Evaluated based on its predictions compared to real-world observations.
Fidelity of the Surrogate Model: Evaluated based on its predictions compared to the corresponding predictions of the original model.

As shown in Tables 1 and 2 below, the surrogate model's performance in predicting real-world observations is comparable to that of the original model. Additionally, its fidelity, when compared to the original model's predictions, is quite acceptable and demonstrates a similar quality in forecasting future values.

TABLE 1
Quality Assessment of the Surrogate Model Against M4 Datasets

| Target Quality | RMSE | SMAPE | R2 |
|---|---|---|---|
| Quality of original model | 4.3 | 0.11 | 0.86 |
| Quality of surrogate model | 5.1 | 0.12 | 0.87 |
| Fidelity of surrogate model | 4.5 | 0.09 | 0.82 |

TABLE 2
Quality Assessment of the Surrogate
Model Against Synthetic Datasets

| Target Quality | RMSE | SMAPE | R2 |
|---|---|---|---|
| Quality of original model | 1.25 | 0.09 | 0.91 |
| Quality of surrogate model | 1.23 | 0.08 | 0.83 |
| Fidelity of surrogate model | 1.26 | 0.09 | 0.89 |

### Machine Learning Model

A machine learning (ML) model is trained using a particular machine learning algorithm. Once trained, input is applied to the machine learning model to make an inference, which may also be referred to herein as an inference output or output.

A machine learning model includes a model data representation or model artifact. A model artifact comprises parameter values, which may be referred to herein as theta values, and which are applied by a machine learning algorithm to the input to generate a predicted output. Training an ML entails determining the theta values of the model artifact. The structure and organization of the theta values depends on the machine learning algorithm.

In supervised training, training data are used by a supervised training algorithm to train a machine learning model. The training data includes input and “known” output. In an embodiment, the supervised training algorithm is an iterative procedure. In each iteration, the machine learning algorithm applies the model artifact and the input to generate an inference. An error or variance between the inference output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or inference, a computer system process executing a machine learning algorithm applies the model artifact against the input to generate an inference output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e., simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e., configurable) implementations of best of breed machine learning algorithms may be found in open-source libraries such as Google's TensorFlow for Python and C++ or Georgia Institute of Technology's MLPack for C++. Shogun is an open-source C++ ML library with adapters for several programing languages including C#, Ruby, Lua, Java, MatLab, R, and Python.

A machine learning engine may include one or more of an input/output module, a data preprocessing module, a model selection module, a training module, an evaluation and tuning module, and/or an inference module. In accordance with an embodiment, an input/output module serves as the primary interface for data entering and exiting the system, managing the flow and integrity of data. This module may accommodate a wide range of data sources and formats to facilitate integration and communication within the machine learning architecture.

In accordance with an embodiment, the data preprocessing module transforms data into a format suitable for use by other modules in the machine learning engine. For example, the data preprocessing module may transform raw data into a normalized or standardized format suitable for training ML models and for processing new data inputs for inference. In an embodiment, the data preprocessing module acts as a bridge between the raw data sources and the analytical capabilities of the machine learning engine.

In an embodiment, the data preprocessing module begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. The data preprocessing module may be configured to handle anomalies in different ways depending on context. The data preprocessing module also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, the data preprocessing module includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when the data preprocessing module processes new data for inference, the data preprocessing module replicates the same preprocessing steps to ensure consistency with the training data format. This helps to avoid discrepancies between the training data format and the inference data format, thereby reducing the likelihood of inaccurate or invalid model predictions.

In an embodiment, a model selection module includes logic for determining the most suitable algorithm or model architecture for a given dataset and problem. This module operates in part by analyzing the characteristics of the input data, such as its dimensionality, distribution, and the type of problem (classification, regression, clustering, etc.).

In accordance with an embodiment, the training module manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. The training module handles the iterative process of feeding the training data into the model, adjusting the model's internal parameters (like weights in neural networks) through backpropagation and optimization algorithms, such as stochastic gradient descent or other algorithms providing similarly useful results.

In an embodiment, the training module includes logic to handle different types of data and learning tasks. For instance, it includes different training routines for supervised learning (where the training data comes with labels) and unsupervised learning (without labeled data). In the case of deep learning models, the training module also manages the complexities of training neural networks that include initializing network weights, choosing activation functions, and setting up neural network layers.

In an embodiment, an inference module transforms raw data into actionable, precise, and contextually relevant inferences. In addition to processing and applying a trained model to new data, the inference module may also include post-processing logic that refines the raw outputs of the model into meaningful insights.

In an embodiment, the inference module incorporates domain-specific adjustments into its post-processing routine. This involves tailoring the model's output to align with specific industry knowledge or contextual information. For example, in financial forecasting, the inference module may adjust predictions based on current market trends, economic indicators, or recent significant events, ensuring that the outputs are both statistically accurate and practically relevant.

In an embodiment, the inference module includes logic to handle uncertainty and ambiguity in the model's predictions. In cases where the inference module outputs a measure of uncertainty, such as in Bayesian inference models, the inference module interprets these uncertainty measures by converting probabilistic distributions or confidence intervals into a format that can be easily understood and acted upon. This provides users with both a prediction and an insight into the confidence level of that prediction. In an embodiment, the inference module includes mechanisms for involving human oversight or integrating the instance into a feedback loop for subsequent analysis and model refinement.

In an embodiment, the inference module formats the final predictions for end-user consumption. Predictions are converted into visualizations, user-friendly reports, or interactive interfaces. In some systems, like recommendation engines, the inference module also integrates feedback mechanisms, where user responses to the predictions are used to continually refine and improve the model, creating a dynamic, self-improving system.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

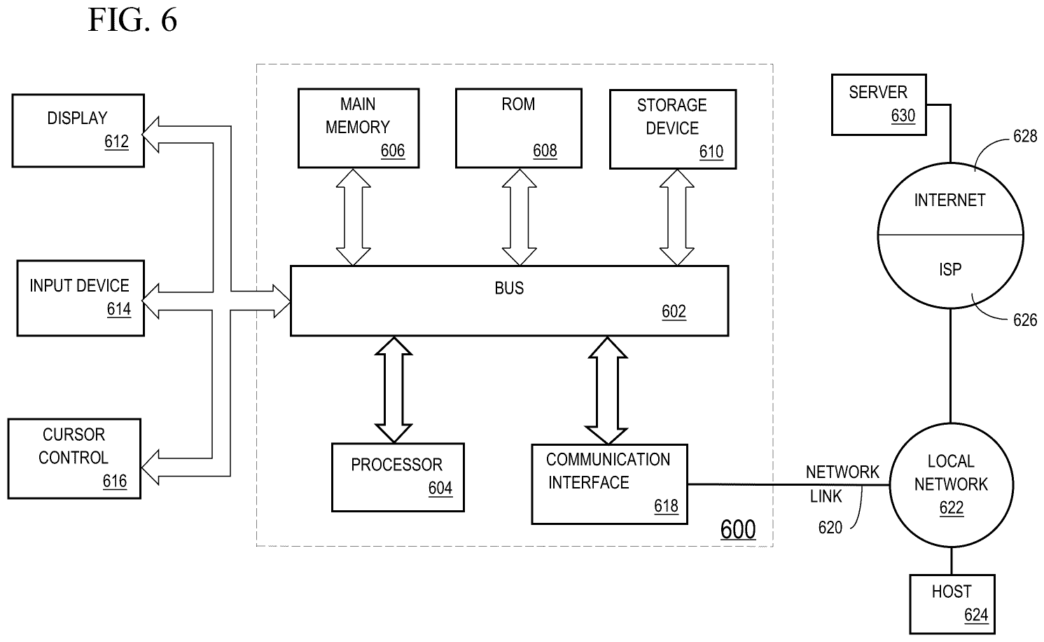

For example, FIG. 6 is a block diagram that illustrates a computer system 600 upon which aspects of the illustrative embodiments may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world-wide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

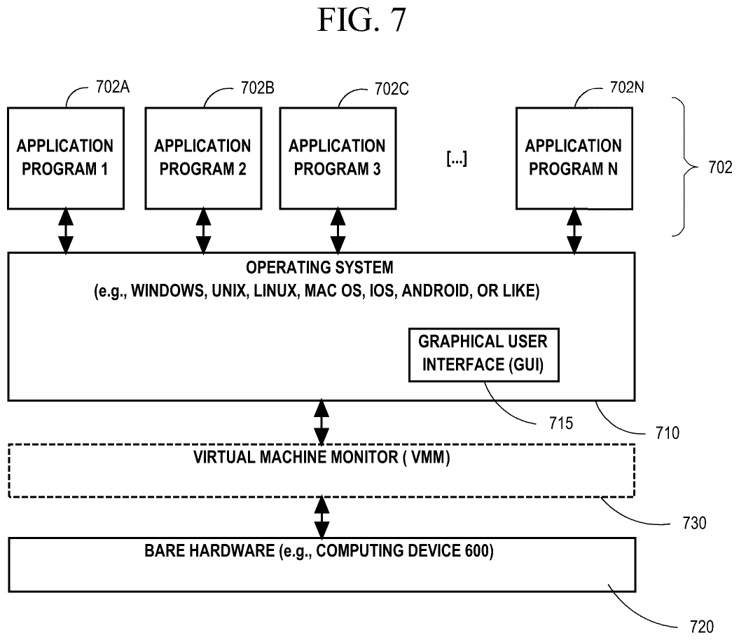

FIG. 7 is a block diagram of a basic software system 700 that may be employed for controlling the operation of computer system 700 upon which aspects of the illustrative embodiments may be implemented. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 700 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an laaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, by a time series forecaster, one or more time series predictions for a set of time series data;
generating, by a surrogate forecaster, one or more approximated predictions for the set of time series data, wherein:
the surrogate forecaster comprises a concept generator and a machine learning (ML) forecaster,
the concept generator extracts a set of concept features for the set of time series data, and
the ML forecaster generates the one or more approximated predictions based on the set of concept features; and
generating a concept-based explanation for the one or more time series predictions based on the set of concept features,
wherein the method is performed by one or more computing devices.

2. The method of claim 1, wherein:
the surrogate forecaster further comprises a time series preprocessor that performs one or more preprocessing operations on the set of time series data to generate a preprocessed set of time series data, and
the concept generator extracts the set of concept features from the preprocessed set of time series data.

3. The method of claim 2, wherein the one or more preprocessing operations comprises at least one of:
de-trending,
power transformation, or
de-scaling.

4. The method of claim 2, wherein:
the one or more preprocessing operations comprises a de-trending operation that removes a trend from the set of time series data, and
generating the one or more approximated predictions comprises adding the trend to the one or more approximated predictions.

5. The method of claim 1, wherein extracting the set of concept features comprises:
determining a window size based on a seasonality period; and
extracting one or more concept features for each of a plurality of sliding windows within the set of time series data.

6. The method of claim 5, wherein the one or more concept features comprises at least one of:
mean,
median,
minimum,
maximum,
kurtosis,
skew, or
variance.

7. The method of claim 1, wherein generating the concept-based explanation comprises using a perturbation-based feature importance technique to generate feature importance values for the set of concept features based on perturbation of one or more concept features within the set of concept features and the one or more approximated predictions generated by the ML forecaster.

8. The method of claim 7, wherein generating the concept-based explanation further comprises performing attribution post-processing on the one or more approximated predictions generated by the ML forecaster.

9. The method of claim 8, wherein the attribution post-processing performs:
inverse-transforming scales of target and reference predictions,
ensuring a sum of attributions matches differences in the target and reference predictions, and
aggregating attributions into understandable concepts.

10. The method of claim 1, further comprising:
generating a contrastive explanation presentation based on the concept-based explanation,
wherein the contrastive explanation presentation identifies a first data point within the set of time series data, identifies a second data point within the one or more time series predictions, and provides an explanation about how one or more of the set of concept features impact the second data point relative to the first data point.

11. One or more non-transitory computer-readable media storing instructions which, when executed by one or more processors, causes:
generating, by a time series forecaster, one or more time series predictions for a set of time series data;
generating, by a surrogate forecaster, one or more approximated predictions for the set of time series data, wherein:
the surrogate forecaster comprises a concept generator and a machine learning (ML) forecaster,
the concept generator extracts a set of concept features for the set of time series data, and
the ML forecaster generates the one or more approximated predictions based on the set of concept features; and
generating a concept-based explanation for the one or more time series predictions based on the set of concept features,
wherein the method is performed by one or more computing devices.

12. The one or more non-transitory computer-readable media of claim 11, wherein:
the surrogate forecaster further comprises a time series preprocessor that performs one or more preprocessing operations on the set of time series data to generate a preprocessed set of time series data, and
the concept generator extracts the set of concept features from the preprocessed set of time series data.

13. The one or more non-transitory computer-readable media of claim 12, wherein the one or more preprocessing operations comprises at least one of:
de-trending,
power transformation, or
de-scaling.

14. The one or more non-transitory computer-readable media of claim 12, wherein:
the one or more preprocessing operations comprises a de-trending operation that removes a trend from the set of time series data, and
generating the one or more approximated predictions comprises adding the trend to the one or more approximated predictions.

15. The one or more non-transitory computer-readable media of claim 11, wherein extracting the set of concept features comprises:
determining a window size based on a seasonality period; and
extracting one or more concept features for each of a plurality of sliding windows within the set of time series data.

16. The one or more non-transitory computer-readable media of claim 15, wherein the one or more concept features comprises at least one of:
mean,
median,
minimum,
maximum,
kurtosis,
skew, or
variance.

17. The one or more non-transitory computer-readable media of claim 11, wherein generating the concept-based explanation comprises using a perturbation-based feature importance technique to generate feature importance values for the set of concept features based on perturbation of one or more concept features within the set of concept features and the one or more approximated predictions generated by the ML forecaster.

18. The one or more non-transitory computer-readable media of claim 17, wherein generating the concept-based explanation further comprises performing attribution post-processing on the one or more approximated predictions generated by the ML forecaster.

19. The one or more non-transitory computer-readable media of claim 18, wherein the attribution post-processing performs:
inverse-transforming scales of target and reference predictions,
ensuring a sum of attributions matches differences in the target and reference predictions, and
aggregating attributions into understandable concepts.

20. The one or more non-transitory computer-readable media of claim 11, further comprising:
generating a contrastive explanation presentation based on the concept-based explanation,
wherein the contrastive explanation presentation identifies a first data point within the set of time series data, identifies a second data point within the one or more time series predictions, and provides an explanation about how one or more of the set of concept features impact the second data point relative to the first data point.
